(19) United States
(12) Patent Application Publication
(10) Pub. No.: US 2014/0207953 A1
(43) Pub. Date: Jul. 24, 2014

(54) Methods and Apparatus for Enabling a Dynamic Network of Interactors According to Personal Trust Levels Between Interactors

(71) Applicant: Forte Internet Software, Inc., Carlsbad, CA (US)

(72) Inventors: Christopher Clemmett Macleod Beck, Carlsbad, CA (US); Mark Franklin Sidell, Chapel Hill, NC (US); Thomas Knox Gold, La Mesa, CA (US); James Karl Powers, Carlsbad, CA (US); Charles Dazler Knuff, Palomar Mountain, CA (US)

(73) Assignee: Forte Internet Software, Inc., Carlsbad, CA (US)

(21) Appl. No.: 14/165,078

(22) Filed: Jan. 27, 2014

Related U.S. Application Data
(63) Continuation of application No. 11/237,269, filed on Sep. 27, 2005.
Application No. 11/237,269 is a continuation-in-part of application No. 10/888,612, filed on Jul. 9, 2004, now Pat. No. 8,250,150.
Application No. 10/888,612 is a continuation-in-part of application No. 10/765,338, filed on Jan. 26, 2004, now Pat. No. 8,316,128.
(60) Provisional application No. 60/677,141, filed on May 2, 2005.

(51) Int. Cl. H04L 29/08

(52) U.S. Cl. CPC H04L 67/10
USPC 709/225

(57) ABSTRACT

A system for causing routing of a communication event includes a sending platform for initiating and sending the communication event, a communications network for carrying the communication event, a receiving platform for receiving the communication event for final routing, and a router resident at least in the receiving platform for preparing and executing or forwarding for execution a routing instruction for handling the incoming communication event or notification thereof, the routing instruction thus executed, overriding a default routing instruction, the overriding routing instruction initiated upon discovery by the router of some level of trust metric between the sender and intended recipient of the event.

### CROSS-REFERENCE TO RELATED APPLICATIONS

The present invention is a continuation application of co-pending application Ser. No. 11/237,269, filed Sep. 27, 2005, which claims priority to provisional application Ser. No. 60/677,141 filed on May 2, 2005. Application Ser. No. 11/237,269 is also a continuation in part to a U.S. patent application Ser. No. 10/888,612 entitled “Methods and Apparatus for Identifying and Facilitating a Social Interaction Structure over a Data Packet Network”, filed on Jul. 9, 2004 which is a CIP to a U.S. patent application Ser. No. 10/765,338 entitled “Methods and System for Creating and Managing Identity Oriented Networked Communication”, filed on Jan. 26, 2004, which is the subject of a document disclosure, number 534495, filed on Jul. 8, 2003. All of the disclosures of all of the above-mentioned documents are included herein in their entirety at least by reference.

### BACKGROUND OF THE INVENTION

1. Field of the Invention

The present invention is in the field of network-based communication including digital transactions and file transfer and pertains particularly to methods and apparatus for enabling a dynamically changing network of communicators based on levels of personal trust that exist between individual ones of the communicators.

2. Discussion of the State of the Art

With the advent and development of the Internet network, including the World Wide Web and other connected sub-networks; the network interaction experience has been continually enriched over the years and much development continues. In a large part, network users, both veteran and novice have a basic human commonality in that they all share three basic desires that materialize into behavioral traits when engaging in network-enhanced interaction. These behavioral traits are the desire for communication with others, the desire to collect and/or acquire digital content, and the desire to collaborate with others to help solve some problem or to resolve an issue. As behavioral traits, these basic needs can be expanded into many sub-categories. Communication includes interaction over channels such as Instant Messaging (IM), email, posting boards, chat, voice over Internet protocol (VoIP), analog voice, etc. Collection includes collecting art, knowledge, music, photographs, software, news, and so on. Collaboration includes group discussions, task fulfillment, and any other collective efforts to solve a problem or perform a function. In basic form communication, collection, and collaboration are very tightly intertwined as basic desires.

As practices many users may unequally engage in the just-mentioned behaviors. For example, virtually all network users have active email accounts and active Instant Messaging capabilities. Most users have IP telephony capabilities and networking collaboration capabilities, at least installed on their computer systems if not actively configured for use. Many users have peer-to-peer file sharing capabilities, often coupled with communication capabilities. General communication may arguably be the most dominant network practice, followed by collection and sharing of content and network collaboration not necessarily in the stated order.

To further illustrate the imbalance of the three core behaviors for any one user consider that some users engage heavily in instant messaging, voice and, or email correspondence, while almost never engaging in file transfers or content downloading. Others engage more heavily in collaboration while lightly engaged in file transfer, content download, and common or casual communication. Still others practice content downloading and file sharing more often than collaboration. One can readily attest that it is difficult to practice one behavior exclusively without also practicing the others to some extent.

Software providers have long recognized the need to fulfill these basic desires by providing the capabilities in a single interface and have provided many well-known communication applications that provide access to casual and business communication as well as collaboration and file transfer capabilities. Programs like Net-Meeting™ and ICQ™, among many others attempt to aggregate these capabilities into a single accessible interface some times integrating separate communications applications for single point launching.

It has occurred to the inventors that in an interface supporting messaging communication, collaboration, and content collection an architecture focused more on message management through user and sender identities would be a far more efficient tool set than what is currently available in the art.

Communication, collaboration, and collection behaviors are all possible and practiced currently with reference to many programs already mentioned above including newsreaders, peer-to-peer applications, chat software programs, directory services, some email clients, and so on. Many users of these applications become overwhelmed when receiving great numbers of messages, sorting through huge address books for contacts, and trying to regulate and manage contacts and downloaded messages and attached files. Most conventions for sorting and filing messages are manual conventions. In other words a user most often than not has to physically create file folders, if those in a list are not sufficient, and manually select and move messages and other content into them.

One drawback in prior-art is that virtually all available applications for communication, collaboration, and collection focus mainly on content management to protect against Spam messages, undesirable downloads or attachments, and other unwanted messages. Content management is handled through user-configured or regulated filters that sort messages, for example, and eliminate those messages found to fit the filter description. Some applications allow you to block messages sent from certain senders based on the sender's identity through a user-created block list or ignore list. Generally speaking though, users must exert much time, effort, and patience to manually configure one or most often more than one application to manage content.

A software application for managing routing of communiqués across one or more communication channels supported by a data-packet-network is known to the inventor and is listed as co-pending application Ser. No. 10/765,338 in the cross reference section of this specification. The software application includes one or more workspaces for segregating communication activity; one or more unique user identities assigned per workspace; and one or more contact identities assigned to and approved to communicate with a workspace administrator of the one or more workspaces using the assigned user identities. In a preferred embodiment the application enforces a policy implicitly defined by the existing architecture of the workspaces and associated user and contact identities.

The application leverages personal and shared collaboration zones and is managed by a firewall including an identity analyzer for verifying identities of those contacts approved for communication relating to any particular communication zone provided by an administrator or created by a user. An enhancement to the above system, listed as co-pending application Ser. No. 10/888,612 is known to the inventor as a software suite for managing the publishing and consumption of information and payload data across one or more transport protocols supported by a data-packet-network. In this implementation, the suite includes a posting application for publishing the information and payload data, and a consuming application for accessing and consuming the information and payload data. In a preferred embodiment the posting application enables posting of information that is consumable separately from the payload data wherein the information richly describes the payload data including provision of instructions for sampling the payload data before consuming the payload data.

While the above system relies heavily on identity oriented routing of messages and file transfers, it does not really leverage all conceivable levels of trust that may actually exist between any two or more users on a network nor trust metrics that might be implied between two or more actors that have some trust metric in common with the one or more established and trusted network users.

When two or more users communicate or collaborate over voice, email, and other channels, there is always an underlying (implied) level of trust between those users. However, in current art is no simple way for users to define their trust relationships and trust metrics that might be implied in communication in software. Furthermore, there is no way to leverage these trust relationships to manage incoming and outgoing messages and media.

Therefore, what is clearly needed in the art is a system and network for communicating various levels of trust implied or existing between actors participating in a dynamically changing interaction network in real time. A system such as this would enable enforcement of levels of trust on more than one hierarchical plane to manage communication access over the network using various communications applications including induction of new users into trust networks already established.

### SUMMARY OF THE INVENTION

According to at least one embodiment of the present invention, a system for causing routing of a communication event is provided. The system includes a sending platform for initiating and sending the communication event, a communications network for carrying the communication event, a receiving platform for receiving the communication event for final routing, and a router resident at least in the receiving platform for preparing and executing or forwarding for execution a routing instruction for handling the incoming communication event or notification thereof, the routing instruction thus executed, overriding a default routing instruction, the overriding routing instruction initiated upon discovery by the router of some level of trust metric between the sender and intended recipient of the event.

In one embodiment, the sending platform is one of a computer station, a telephone system, a cellular telephone, a personal digital assistant, a pager, a voice over Internet protocol phone, an Internet protocol telephone, or a video teleconferencing system. In the same embodiment, the receiving platform is one of a computer station, a telephone system, a cellular telephone, a personal digital assistant, a pager, a voice over Internet protocol phone, an Internet protocol telephone, or a video teleconferencing system.

In one embodiment, the communications network is the Internet network. In another embodiment, the network is the Internet network and a telephone network integrated for communication through a bridging facility. In this embodiment, the Internet network includes connected sub-networks and the telephone network includes wireless carrier networks.

In one embodiment, the communication event is one of an email, a voice mail, a telephone call notification, a video call notification, an instant message, a page, an Internet protocol telephony call notification, a file transfer request, or an invitation message to engage in a communication sequence.

In one embodiment of the present invention, the receiving platform is a central routing facility. In still another embodiment, the receiving platform is an interactive voice response system connected to a routing system. In one embodiment, the router is a software application having a graphic user interface including a portion thereof for providing system recommendations about trust plausibility associated with received events and for providing system recommendations of trust related to contacts available in a network directory.

In another embodiment, the router is a routine integrated with a firewall or other message filtering system. In a preferred embodiment, a router is resident in the sending platform and in the receiving platform.

In one embodiment, the router generates an extensible markup language-based trust interaction markup language from stored interaction history and contact parameters. In an embodiment where there is a router in the receiving and sending platform, the routers generate an extensible markup language-based trust interaction markup language from stored interaction history and contact parameters.

In a preferred embodiment, the level of trust for a contact is configurable to extend trust beyond direct trust of the contact to users who are trusted by the contact. In a variation of this embodiment the level of trust for a contact and trusted users of the contact is configurable to a granularity of trusting or not trusting communications event types, and file types of attachments associated with those events.

According to another aspect of the present invention, a router is provided for preparing and executing or forwarding for execution a routing instruction. The router includes a data conversion module for generating metadata from stored data, a data communication module for sending and receiving metadata generated from stored data, a data processing module for processing metadata sets, such processing sequence resulting in a positive or a negative determination of a trust relationship, and an instruction generation module for generating a routing instruction useable by an associated routing system.

In a preferred embodiment, the router is resident in and operable on a network-capable communications device as a software application. In one embodiment, the network-capable communications device is one of a desktop computer, a personal digital assistant, a laptop computer, an IP telephone, a cellular telephone, or an interactive media server.

In another embodiment, the router is resident in and operable on a telephony switch. In still another embodiment, the router is embedded in an interactive voice response system.

In one embodiment, the metadata is extensible markup language-based trust interaction markup language and the stored data is communication history data and contact parameters. Also in one embodiment, metadata data is sent by attaching the metadata to a communications event for send and wherein metadata is received by stripping it from an incoming communications event.

In one embodiment, data is sent over a communications link to another router, the communication link established by the sending router, and wherein data is received over a communications link established by a sending router, the data received at a receiving router. In another aspect, the router further includes a graphic user interface for registering the router on a network and for configuring the router functions including a portion thereof for providing system recommendations about trust plausibility associated with received events and for providing system recommendations of trust related to contacts available in a network directory.

In one embodiment the metadata is trust interaction markup language extensible from social group description markup language, the trust interaction markup language transported using simple object access protocol over transfer control protocol/Internet protocol, user data gram protocol, news network transfer protocol, session initiation protocol, or computer telephony integration protocols. In another embodiment, the trust interaction markup language is an extension of contact center extensible markup language.

In still another aspect of the present invention, a method for routing a communication event or notification thereof based on an implied level of trust using a trust-based router at a receiving platform is provided. The method includes steps for (a) pre-configuring the router to trust at least one contact and at least one user that the contact trusts, (b) receiving a communication event or notification thereof at the receiving platform, (c) notifying the router of the received communication event or notification thereof, (d) launching the router, the router accessing local data and receiving any data attached to the communication event or sent directly thereto from a sending router, (e) comparing the data sets and discovering some indication of a trust relationship between the sender and receiver of the communications event or notification thereof, (f) preparing a routing instruction for handling the communications event or notification thereof according to the trust relationship discovered, and (g) causing execution of the routing instruction according to the trust relationship discovered.

In one aspect, in step (a), the identity of the at least one user is not known to the host platform of the router configured for trust. Also in one aspect, in step (b), the communication event is one of an email, a telephone call notification, a video call notification, an instant message, a page, an Internet protocol telephony call notification, a file transfer request, or an invitation message to engage in a communication sequence. In a preferred aspect, in step (b), the receiving platform is one of a computer station, a telephone system, a cellular telephone, a personal digital assistant, a pager, a voice over Internet protocol phone, an Internet protocol telephone, or a video teleconferencing system.

In one aspect, in step (d), the data received is extensible markup language-base trust interaction markup language. In one aspect, in step (d), the data accessed is interaction history and contact identity information, including trust metrics, if any set for those identities. In one aspect of the method according to an implied trust, in step (e), the trust relationship is implied or suggested by the system, but not necessarily approved by the operator of the receiving platform. In this aspect, a step is provided between steps (e) and (f) for enabling the operator to approve or reject a suggested or implied trust relationship.

In a preferred aspect, in step (f), the routing instruction overrides an existing default instruction in place for routing the event or notification thereof. In one aspect, in step (g), the router causes execution of the routing instruction through an application program interface to the default routing system for the communications event type. In still another aspect of the method a step (h) is added for dynamically tuning trust metrics relevant to the discovered trust relationship. In a variation of this aspect, the tuning includes adding the identity of the sender to a trusted contact list for the type of communication of the event or notification thereof.

In one aspect in a variation of implied trust advisement, the trust relationship discovered relates to one or more contacts included in a network-based directory the discovery communicated to the sender as an advisory before routing an outbound event to the one or more contacts.

### BRIEF DESCRIPTION OF THE DRAWING FIGURES

FIG. 1 is an architectural overview of a communications network wherein trust-based routing is practiced according to one embodiment of the present invention.

FIG. 2 is a block diagram illustrating components of a trust based router application according to an embodiment of the present invention.

FIG. 3 is a block diagram illustrating interaction between a central trust-based router functioning as a moderator and other trust based routers in the network according to an embodiment of the present invention.

FIG. 4 is an architectural overview of an identity-oriented routing system enhanced with trust-based routing according to an embodiment of the present invention.

FIG. 5 is a plan view of a configuration user interface for establishing and modifying trust metrics according to an embodiment of the present invention.

FIG. 6 is a process flow chart illustrating steps for verifying trust metrics in an ad hoc communication sequence according to an embodiment of the present invention.

FIG. 7 is a process flow chart illustrating steps for verifying trust metrics in a proxy communication sequence according to an embodiment of the present invention.

### DETAILED DESCRIPTION

According to various embodiments of the present invention, the inventor provides methods and apparatus for routing communications over a data packet network based on actual and implied levels of trust that may exist between certain actors communicating amongst each other over the network. The methods and apparatus will be explained in enabling detail below.

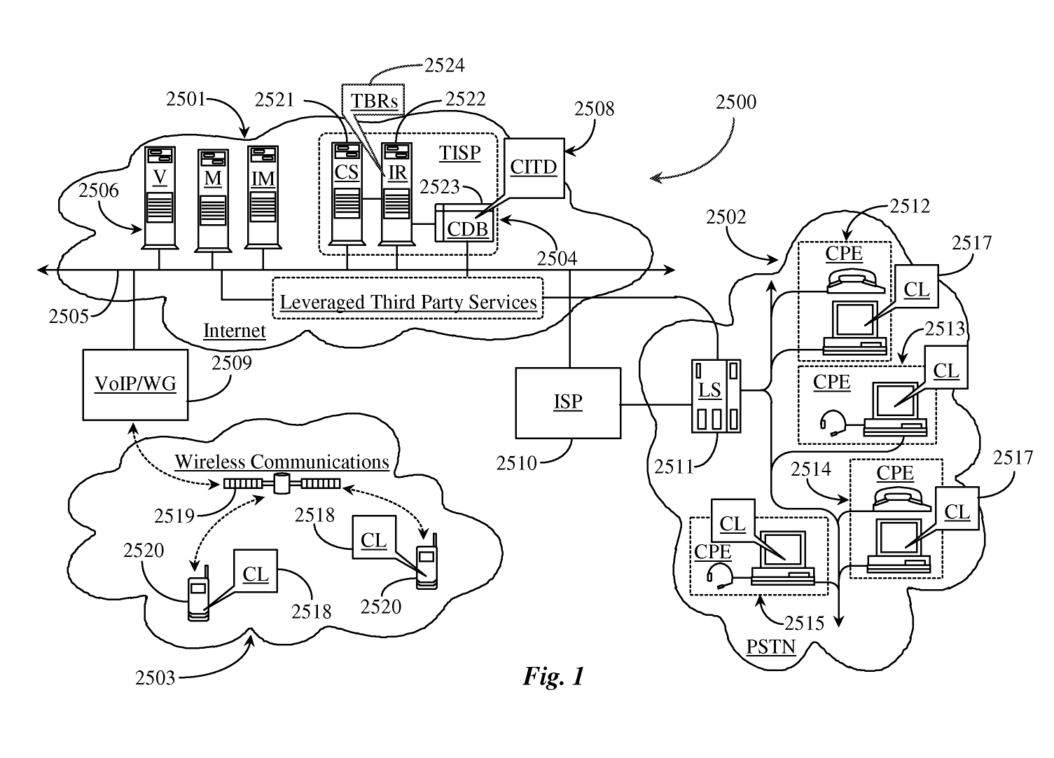

FIG. 1 is an architectural overview of a communications network 2500 wherein trust-based routing is practiced according to one embodiment of the present invention. Communications network 2500 comprises a data packet network 2501, hereinafter referred to as an Internet network 2501, a public switched telephone network (PSTN) 2502, and a wireless communications network 2503. Internet network 2501 may be another type of wide area network (WAN) without departing from the spirit and scope of the present invention. Internet 2501 may also be a municipal area network (MAN) segment without departing from the spirit and scope of the present invention. The inventor chooses the broad example of the Internet because of a high public access characteristic and to demonstrate that there are no geographic limitations to the practice of the present invention.

Networks 2502 and 2503 may be considered access networks used by consumers to access the broader Internet network to facilitate networking and file transfer activity between users and other users and between users and services hosted in any of the three network segments illustrated. PSTN 2502 may be a private telephone network without departing from the spirit and scope of the present invention. The inventor chooses a PSTN because of a high public access and use characteristic. Network segment 2503 represents a wireless communication network capable of digital cellular transmission, or analog telephony depending on end-device capability.

Internet 2501 has an Internet backbone 2505 extending there through that represents all of the lines, access points, and equipment that make up the Internet network as a whole including sub-networks. A trust interaction service provider (TISP) 2504 is illustrated within Internet 2501 and represents a service provider that provides trust-based networking services to consumers. TISP 2504 includes a client server 2521, connected to backbone 2505 for communication, and an Internet Protocol router IR 2522, also connected to backbone 2505 for communication. Client server 2521 provides electronic information including registration and client configuration services to enable clients to access and subscribe to services and to login to manage services. IR 2522 is provided for the purpose of routing trust-based messages and other communiqués among clients belonging to one or more trust-based communication networks enabled by the host.

In this embodiment, access to TISP 2504 from access networks PSTN 2502 and wireless communications network 2503 is enabled by an Internet service provider (ISP) 2510 for PSTN 2502 and a Voice over Internet Protocol/Wireless Gateway (VoIP/WG) 2509 for wireless communications network 2503. Other sub-networks and access gateways and services may be provided and enabled to practice the invention without departing from the spirit and scope of the present invention. For example, ISP 2510 is connected to a local telephone switch 2511 illustrated within PSTN 2502 accordingly for a standard Internet dial-up access service. However, Internet access may include digital services network (DSL) lines and equipment or cable/modem lines and equipment and the appropriate service provider connection services. There are numerous access alternatives.

PSTN 2502 includes a number of customer premise equipment (CPE) locations illustrated herein as CPE 2512, CPE 2513, CPE 2514, and CPE 2515. Each CPE 1212-1215 includes at least a computer appliance for connecting to the network illustrated herein as a computer icon within each CPE. A voice-connection device is available within each CPE and is illustrated in CPE 2512 and in CPE 2514 as a standard telephone and in CPE 2513 and CPE 2515 as a headset connected to the associated computer for IP telephony. One with skill in the art then will appreciate that standard cost oriented switched telephony services and at least IP telephony services are available to consumers from within PSTN 2502.

Wireless communications network 2503 includes smart mobile telephones 2520 and a wireless communications relay 2519, which in this case is a satellite, but may also be a cell tower. Users operating mobile telephones 2520 may access the Internet and conduct voice sessions using a variety of channels including Internet access and voice services conducted simultaneously from a single device. One with skill in the art will appreciate that other types of network-capable communication devices may also be represented in this embodiment without departing from the spirit and scope of the present invention including wireless Laptop appliances, hand-held mini-computing devices such as a Palm pilot™, Blackberry™ and so on. The only requirement for practicing the invention with a network appliance is a network navigation capability and at least one asynchronous or synchronous communication application like email, instant messaging, simple messaging service (SMS), or a voice application or device.

Generally speaking for each illustrated CPE in PSTN 2502 and for telephones 2520, there will be more than one available communications application installed that may enable the user to access Internet 2501 for communicating. Likewise, communication may take place between users of networks 2502 and 2503 without accessing Internet 2501. One with skill in the art will appreciate that appropriate network-communications bridging equipment is available for routing communiqués between users in disparate networks such as between a telephone in PSTN 2502 and a telephony application running on an Internet-connected computer appliance, for example, As the state of services exist today, communications between all of the illustrated networks is conducted relatively seamlessly with good quality where voice and video services are concerned.

In one embodiment, TISP 2504 provides trust-based networking and communications routing services for consumers as previously described above. In this embodiment, each CPE-based computing appliance illustrated within CPEs 2512-2515, for example, has a client software (CL) application 2517 provided thereto for the purpose of enabling practice and configuration and management of trust-based routing of communications and data transfers. Unlike strict identity oriented routing discussed with reference to co-pending application Ser. Nos. 10/765,338, and 10/888,612, trust-based routing extends identity routing conventions to more than one possible level of implied trust with reference to building a trust network of users who publicly trust certain other users to varying degrees or levels configurable for each user by each user. CL instances 2517 are adapted, in this example, to enable at least a user interface for enabling a user to configure levels of trust for known contacts with respect to those listed in address books or other contact lists or directories pertinent to any communications application or device the user may engage for communication or data transfer with other users.

Smart telephones 2520 each have an instance of CL 2518, which is adapted like instance 2517 for the same purpose of enabling at least a UI for configuring various trust levels and metrics for trust-based routing. Device 2520 may have a telephone contact list, an email contact list, an instant messaging contact list, and other lists pertinent to any other possible communications application or configured device. In this particular example, CLs 2517 and 2518 communicate primarily with CS 2521 during the course of set-up, configuration and ongoing management of services.

Each client of TISP 2504 has personal space in a client database (CDB) illustrated herein as CDB 2523 connected to IR 2522. CDB 2523 contains client interaction and trust data (CITD) 2508 that is maintained for each client. CITD 2508 for any one client contains interaction history logs accumulated by that client during the normal course of interaction using any of his or her communications applications or devices that are configured to the trust network service. CITD 2508 may also include contact parameters of other users that are listed as contacts for one or more communications applications or zones and any pre-configured trust metrics associated with those contacts. These values may be maintained according to each separate communication application, across more than one communication application, or across all communications applications or devices configured to use trust-based routing. In one embodiment of the present invention, the CITD data resides in CDB 2523 in the form of an extensible markup language XML known a trust interaction markup language (TIML) to the inventor. TIML may be thought of, in one embodiment, as a counterpart to social interaction markup language (SIML) described as an extension of social group description language with respect to co-pending application Ser. No. 10/765,338.

IR 2522 has multiple trust-based routers (TBRs) 2524 provided and installed thereon and executable there from, which are adapted, in this case, as personalized routing modules that can communicate with each other and that may collaborate in formulating an opinion. TBRs 2524 may, in one embodiment, represent multiple spawned instances of a generic trust-based routing application. In this embodiment, TBRs 2524 are all hosted in the network cloud, more specifically, within server IR 2522. In another embodiment, TBRs 2524 may be hosted on user computers or other user operated devices like one or more smart phones 2520. One with skill in the art of software versioning will appreciate that CL instance 2517 and 2518 may be provided in various configurations or forms as may be required run successfully on any supported network appliance. For example, an instance may be provided to and adapted for a cellular telephone while another instance of the same functional application may be provided to and adapted to run on a desktop computer station. Applications may be provided as well for disparate operating systems and computer platforms.

Internet backbone 2505 supports a variety of communication services 2506 like an instant messaging service (IM), an email messaging service (M), or a voice message service (V). Other types of known communications services like chat services, news services, and file download services may also be represented herein and leveraged for communication and/or data transfers as are generally available to consumers. Therefore all forms of communications like email, instant messaging (IM), simple messaging services (SMS), file transfer protocol (FTP), peer-to-peer file sharing, collaboration programs, IP telephony, VoIP, video mail, video conferencing, teleconference, and telephone may all be considered supported in some embodiment for trust networking.

TISP 2508 provides trust-based routers and configuration interfaces for individual consumers to use in setting up and managing their own trust networks. For example, CL 2517 may be used to establish TBR integration to any supported communication application available to the user. A user may designate other users who also subscribe to the service as trusted contacts according to a pre-determined and user-specified trust level that enables dynamic influx of other users trusted to some degree of separation into the network according to a system-implied trust metric. In this way, an ad hoc trust network may be formed and may dynamically evolve into a more structured trust network that may eventually become a hosted or published trust network.

TBRs 2524 may, in one embodiment, reside on client devices along with instances of CL 2517 or CL 2518 or in integration therewith. Therefore at least in one embodiment, trust networking may be practiced without management or hosting from any centralized node or location. The advantage of hosting a trust network from a centralized facility applies to larger trust networks that routinely experience much more data traffic than would smaller ad hoc trust networks.

To practice the invention, a user operating a CL instance 2517 or 2518 first configures his or her trust-based router to one or more desired communications channels generally through an application program interface (API) plug-in adapted for the purpose. Next, the user may designate any contacts in any of the contact lists associated with supported communications programs as individuals whom may be trusted during communication over any of the applied communications channels. There may be more than one trust level that may be applied to any contact or list of contacts. For example, a user Joe may decide to trust a user Jim for communication over an email channel to a level of direct trust plus one degree of separation. This means that Joe has agreed to trust Jim and any email contact that Jim trusts implicitly even though Joe may not have had contact with them or knows their contact parameters. Granularity in configuring a trust metric for one or more contacts can vary widely. A trust metric may apply to a single contact over multiple communication channels, file types, zones, and so on.

In a hosted embodiment, Joe my add Jim to a trust network whereupon Jim may receive notification from the system that he or she is requested to join the network and download his own CL instance and configure his own trust metrics. Once Joe and Jim are part of the same trust network, then the TBRs of Joe and Jim make an information exchange for each initiated contact between them for any of the mutually supported communications channels. It is noted herein that Joe may trust Jim more than Jim trusts Joe in communication. The reverse may also be true. Each user is in complete control over who is or is not trusted and to what level for what communications, zones, file types, and so on.

In a hosted embodiment Jim, who may be operating at CPE 2515 for example, initiates a communication, say email, to Joe operating CPE 2512 for exemplary purposes. Before Jim sends the email to Joe, his CL instance establishes a connection to his TBR 2524 operating in IR 2522. All of the contact parameters of the email, for example, sender ID and destination ID are sent to Jim's TBR. Jims TBR then accesses Jims TIML data stored in CDB 2504. In the meantime, Joe's email system receives Jim's email message and notifies Joe's TBR, which like Jim's TBR accesses TIML data for JIM. The TBRs compare the TIML data sets to confirm the commonalities shared by Jim and Joe including the latest trust metrics for the email channel. Joes TBR sends an instruction to his email application telling the application how to route the incoming message. The actual messaging is routed over the network using the standard techniques and equipment that would normally be in play. The only contact in this case between the users and TISP 2508 is during send and receive over the communication channel.

TBR capability may be added to existing security regimens already installed on a user's system or on a user network like a firewall or any messaging filter program. If trust-based routing is set to default pertaining to those security regimens then establishment of a trust relationship between new users may override normal message filtering and handling. In one embodiment, TISP 2504 may be adapted to actually provide certain messaging services and communications routing services like email, chat, news posting, and the like as described with respect to co-pending application Ser. No. 10/765,338, however it is not required in order to practice the present invention. In an embodiment where TISP 2504 actually physically handles routing of communication, then TBR data may be attached to actual messages and then stripped at the destination (TISP) for trust-based authentication. In this embodiment, it is possible that a user may be trusted to have access to a trusted contact's directory (shared directory), however certain parameters may be held secret to the user like telephone numbers or email addresses of certain contacts in the directory. Hence, the service provider may place a call, email, instant message, or other communication event by proxy on behalf of the user whereupon the recipient's TBR may route the message and make a decision to publish or not to publish the particular contact parameter back to the user. In this way, anonymous outbound interactions may be supported.

In an ad hoc embodiment where no centralized facility like TISP 2504 is used, then TBRs 2524 reside as client applications directly on the devices used for communication or on connected peripheral or host devices. In this embodiment, Joe may initiate an email to Jim wherein Joe's TBR will access TIML data and attach it directly to the sent message. The TIML data accompanies the message until the end point where it is stripped by the end TBR and used to compare against TIML at the end point to establish a trust relationship between the sender and receiver. Depending on the identities used in constructing a message or that are associated with a communication, TIML data may be generated in real time at either or both sending and receiving stations and compared for establishing a trust relationship before the end point provides final routing and message handling.

The use of trust-based routing in an automated fashion as described enables a new user, perhaps one trusted by Joe but not known to Jim, to send a message to Jim and to be immediately recognized as a user that can be trusted for the form of communication used. For example, if the new user has a direct trust relationship established with Joe, then the TBR of the new user would reflect that relationship at least for the channel used. When Jim receives the message, his TBR will recognize that Joe trusts the new user and that Jim's trust metrics for Joe state that Jim trusts Joe and any one Joe trusts directly. Therefore the new message may be routed to Jim's trusted mail folder overriding Jim's normal Spam filtering or other firewall treatments for the channel.

The use of TBR transcends traditional network borders and may be used between actors leveraging very different communications devices and programs without departing from the spirit and scope of the present invention. All that is required is that the TBR instances can access data, generate TIML, and collaborate to authenticate a trust relationship. Appropriate APIs may be provided to transfer final recommendations or routing instruction to end systems whether they are digital data routing systems or even analog voice routing systems. For example, a user operating a cellular telephone 2520 may send an SMS to a user operating a computer in CPE 2515 whereupon trust authentication is used to determine if the SMS will be accepted or not at CPE 2515. Synchronous services like real-time VoIP and other voice telephony services can also be supported in the same fashion. All that is required is a TBR interaction at the pickup point of a call and normal call handling software can be instructed to override normal call handling and final routing if a trust relationship is established.

While the above examples are described assuming a TBR is available at both send and receive stations, or if in the cloud, one for each actor, that is not specifically required in order to practice the present invention according to certain embodiments. For example, in a given trust network of more than one user, it is possible that a new user can be invited to join the network and subsequently receive the client software including a TBR. In this embodiment it may be that the new user messages a trusted user with TBR that communicates with a cooperative TBR that has access to all of the other TBRs for actors of that particular network.

In the above case the destination TBR may not recognize the user because there is no TIML data sent with the user's message (also indicative that the user is not running a TBR for that channel). The destination TBR may then request a session with the coop TBR that has access to TIML from all of the other TBRs making up the network. It may be determined then that for the channel used one or more of the other actors may have established interaction histories with the user, including some indication of trust metric specified for the user even though the user has no TBR installed. The system may then make a recommendation to the receiving TBR to go ahead and trust the user for that particular message and the user may then be invited by the system to download his or her own TBR and client application and to register for enhanced services.

Trust metrics may be pre-configured to operate statically or dynamically depending on the wishes of a user configuring the trust relationships. For example, a trust relationship level established or granted for a particular contact for a particular channel may be adapted to change dynamically based on some other business or performance statistic that may avail itself to the system over time and interaction history between the actors. More detail about dynamic trust relationships will be provided later in this specification.

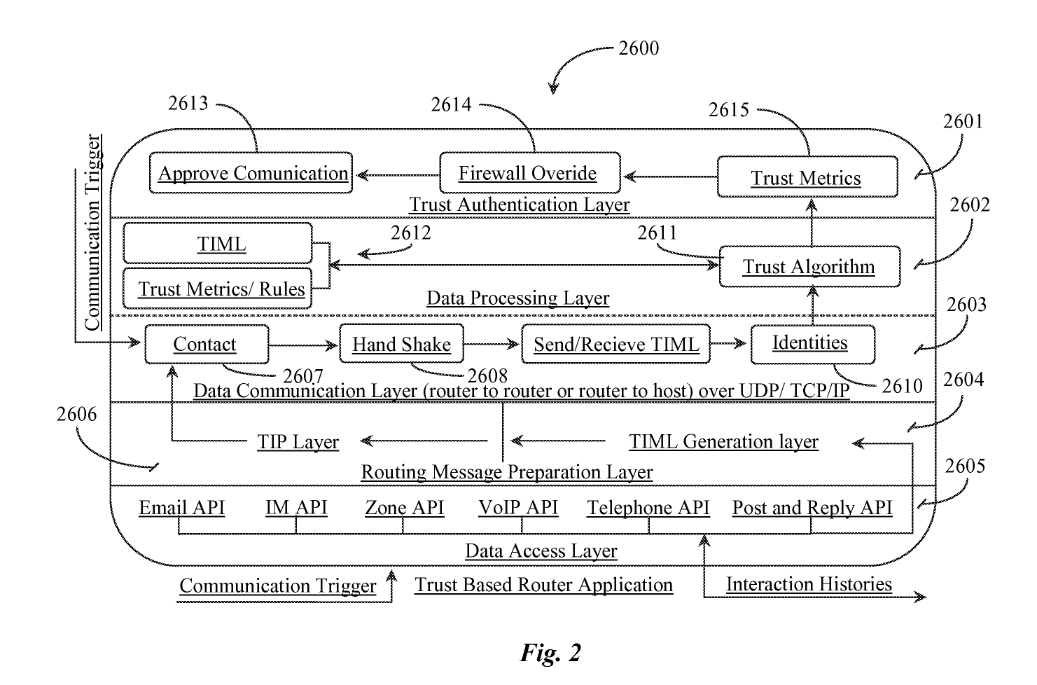

FIG. 2 is a block diagram illustrating components and component interactivity of a trust based router application 2600 according to an embodiment of the present invention. Application 2600 (TBR) includes a plurality of software layers in one embodiment. Application 2600 includes, for example, a data access layer 2605. Data access layer 2605 is adapted to enable application-access to various interaction histories pertinent to supported communications applications, which may be configured to trust metrics. Application 2600 may be analogous to TBRs 2524, in one embodiment, described with reference to FIG. 1 above. Application 2600, in another embodiment, may be analogous to a TBR combined with one of CL instances 2517 or 2518 of FIG. 1 without departing from the spirit and scope of the present invention.

Within data access layer 2605, there is a plurality of application program interfaces (APIs), which are pertinent to communications applications and, in one case, a messaging zone or workspace. For example, reading from left to right in data access layer 2605, there is an Email API, an IM API, a Zone API, a VoIP API, a telephony API, and a Post and Reply API. The purpose for APIs in the data access layer is to provide integration and application access to various contact lists and interaction histories associated with those different communications programs and/or zones.

The email API provides application integration to one or more of a user's email programs including provision of application access to email interactions logs or histories, email address books, email white lists, email black lists, and so one for one default program or for more than one program. The IM API provides application integration to one or more of a user's IM programs including provision of application access to IM interaction logs or histories, IM buddy lists, or other IM contact lists, and IM block lists that may be available. The Zone API provides application integration to one or more of a user's personal zones analogous to those zones described with respect to the co-pending applications listed above in the cross-reference section of this specification. In a zone-enabled embodiment, a user may have a plurality of separate messaging zones broadly or narrowly whereby each zone typically has a list of approved contacts and, in one embodiment, an interaction history logged for communication taking place through a particular zone. It is important to note herein that a zone may be specific to a category of social interaction as described with reference to co-pending application Ser. No. 10/765,338. Likewise, a zone may also support more than one communication application.

The VoIP API provides application integration to one or more of a user's VoIP programs including application access to VoIP interaction logs or histories, VoIP contact identities, and so on. The telephone API provides application access to one or more of a user's telephone system devices, including telephone interaction logs, call logs, and telephone contact lists associated with a particular telephone number, of which there may be more than one configured for trust metrics. The Post and Reply API provides application integration to a user's program used to post and receive messages such as when using a news reader or some other browser-based plug-in.

In one embodiment wherein trust interaction routing is hosted by a service, API's might be developed for applications servicing other communities such as member organizations, scholastic groups, and others that have existing networks that they use to collaborate. In this embodiment, certain trust metrics may be recommended or implied by the system and which may be integrated into the trust-network cache of available contacts or contact lists. One example of such interaction might be a trust network formed between several medical professionals collaborating to better understand a condition or to stay on top of medical advances. The system may recommend that certain contact lists or individual contacts from an established medical association or group be made available to the trust network to enhance their network and expand their resources. A system administrator of a member portal used by the established group may grant permission for this, perhaps. An API then may be developed to facilitate communication through the server used by the group. Depending on the form of communication proxied by the group server, secondary communication applications may also be used. Certain experts from the group may agree to be used as resource contacts and therefore their contact information may be published to the trust network for subsequent publishing to users of the trust network through system recommendation. In this way, a trust network may expand resource, especially if it is a valuable network that may contribute something to society, business, technology, or to the community in general.

Other communications applications not illustrated in this example including associated contact lists and interaction logs or histories may be supported for trust based routing without departing from the spirit and scope of the present invention. It is noted herein that those program types illustrated are exemplary and optional in terms of configuration. For example, a user may only have a default email program configured for trust-based routing but not an instant messaging application. Likewise, a user may or may not utilize zones adapted for identity-oriented routing. The APIs may also provide command access for application 2600 for the purpose of sending routing instructions to the routing system used by the application that may override default handling of messages or communication event routing in some instances.

An email routing system would, for example, be a separate system than a telephone routing system. Therefore, two separate APIs may be provided. Likewise, all interaction histories, contact lists, and communications ports may not all exist on one machine. Therefore, application 2600 may be provided in distributable versions residing on more than one device. For example, a version may reside on a cell telephone, a version may reside on a PDA, and a version may reside on the desktop. The separate versions may be enabled to communicate with one another in a cooperative fashion using normal networking protocols existing for communication between devices over the prevailing networks. In this way, a single TBR application 2600 may be provided as more than one cooperative part or portion. In one embodiment, a TBR application or a version thereof may be provided within a media server application to run trust metrics before serving specific media requests to users. More detail about the capabilities of application 2600 is provided later in this example.

Application 2600 has a routing message preparation layer comprising a TIML generation layer 2604 and a trust interaction protocol (TIP) layer 2606. In a preferred embodiment of the invention, TIML is a set of XML-based constructs used to describe trust-based data and rules similar in scope to social interaction markup language (SIML) described with reference to co-pending application 8600. Likewise, TIP may be thought of as a variation of social interaction protocol (SIP). Mechanically the markup language and protocols are very similar but the content communicated, rules observed, and processes involved in trust-based routing differ somewhat from the counterparts described in identity oriented management covered in the co-pending patent applications.

TIML generation layer 2604 creates a set of XML-based data or metadata sets that richly describe interaction history and contact parameters found for any one or more identities associated with a communication event initiated by a user. TIP layer 2606 determines any existing trust metrics and the appropriate standard network protocols and packaging protocols that will be used to communicate the TIML data set to a destination point, which in a preferred embodiment, is a TBR application similarly adapted as application 2600. In this way bi-directional communication exists between TBR applications. XML-based TIML may be sent using simple object access protocol (SOAP) over TCP/IP, UDP, news network transport protocol (NNTP), and other standard protocols including those protocols available in computer integrated telephony (CTI) environments. TIML may be made an extension of contact center (CC XML), which is a known markup for transporting telephone event information including routing instructions.

TBR 2600 has a data communication layer 2603 provided thereto and adapted with network components to initiate and establish a communication link with another TBR application over a data network. The communication link established may be a point-to-point TCP/IP or UDP link, or a link established via a proxy. In one embodiment of the present invention, the communications link established may be maintained over disparate networks like one initiated from a cellular network, bridges through the Internet network and then received in the PSTN network, for example. In this case, one with skill in the art will recognize that the PSTN-based TBR application may actually reside on a telephone answering system.

In still another embodiment of the present invention, TBR applications like application 2600 are invoked only when initiating and receiving communication events, whereupon invocation thereof at the receiving end enable the TBR application to strip the required data from a received communiqué. In still another embodiment, TBR applications like application 2600 are adapted to communicate with a centralized TBR application acting as a proxy or cooperative application.

In one embodiment, TBR applications actually establish a communication link between them that may be a separate link from any active communications channel. In this embodiment, TBR 2600 is invoked as previously describe above when a user initiates a communication event to a contact from a zone or communications program covered for TBR. The communication event is mined for data including at least ID information of both the sender and the final destination. TBR 2600 compiles the TIML from previous interaction history associated with the identities and the communication program, including any additional rules for including other program communication interaction history. TIP layer 2606 establishes any existing trust metrics concerning the TIML data.

Instead of attaching the TIML set to the communication event before send, TBR 2600 may initiate contact to the destination TBR, if one is known to exist. This is illustrated as contact 2607. TBR 2600 establishes a link with the destination TBR via some handshake protocol 2608, which may vary somewhat depending on the exact protocols used to establish the link. TBR 2600 sends its TIML data to the destination router, which receives the TIML data. The TIML data may include identities 2610 other than the identities listed in the communication event. TBR 2600 has a data processing layer 2602 provided thereto and adapted to enable processing of TIML data sets from both the sending point and from the receiving point. Therefore whichever TBR is the receiving router compiles its own TIML data set from its own interaction histories relevant to identities 2610 and accompanying metrics. This is illustrated in this logical example as blocks 2612 labeled TIML and Trust Metrics/Rules. At the receiving end, a trust algorithm 2611, after receiving TIML data and trust metrics from the sending TBR, fetches or compiles TIML data and trust metrics 2612. Therefore, all of the calculation is performed by the receiving TBR for any communication event.

Trust algorithm 2611 compares both TIML data sets and looks for commonalities between them that may be ruled an existing trust relationship that agrees with the trust metrics set up at the receiving end. The resulting value from trust algorithm 2615 is identification of a trust metric or metrics 2615 that may include instructions for handling the communication event. It is noted herein that the receiving TBR, like the sending TBR is configured to the appropriate communications channels used and may therefore identify the appropriate incoming communication event that is identified in TIML by the sending TBR. The receiving TBR then has access to all of the appropriate event queues and may even look for the incoming event before it has arrived if it has already received the TIML from the sending router. In a point-to-point communication example, it is important, in some cases that the TIML from the sending TBR arrive before the communication event simply because there may be automated routing routines in place that may trigger default routing in the absence of interference by the receiving TBR.

TBR 2600 has a trust authentication layer 2601 provided thereto and adapted in the receiving mode to implement the findings of trust algorithm 2611. Trust metrics 2615 may be used as instructions for overriding any default handling or filtering that may otherwise take place. In this example a firewall override operation 2614 is ordered by the receiving TBR because a trust relationship has been established between the sending actor and the receiving actor that indicates after TIML comparison, that the arriving communication event can be trusted. The final block approve communication 2613 represents the final action in the event of an established trust relationship. Alternatively, algorithm 2611 may provide trust metrics that are negative or not indicative that the event can be trusted. In this case, normal in-place firewall routines or other filtering and routing routines for that communication channel would file by default as they would for any other incoming event.

In the second of the 3 embodiments describe further above, TBR routers may operate without having an established link between them. In this embodiment, which may be more common, the TIML data set is attached using the appropriate protocols to the communication event being sent. The end TBR is invoked only after the event has been received and recognized to have TIML data attached thereto for read. The end TBR in this case, strips the TIML data from the incoming event and compares it with its own TIML data that it may compile in real time after mining the received TIML for identities and communication program application. In this case as well as the previous case, algorithm 2611 is fired to attempt to establish a trust relationship between the sending actor and the destination actor accordingly. It is noted herein that as communication ensues, new trust metrics and rules may dynamically evolve by suggestion of the system so that new contacts, previously having no metrics, may have those metrics established directly rather that just through implication. Likewise, levels of trust may dynamically evolve through continued communication where trust levels are associated at least in part, to some performance metric.

In one embodiment of the present invention, one end of a communication between TBRs may be a machine such as an interactive voice response (IVR) system adapted for customer service. In this embodiment, trust levels may be automatically granted to all first time customers. Trust levels then may dynamically degrade for some customers based on their performance behavior with the system determined through continued interaction events conducted by the same actor with the system. In this case trust metrics may be tied in some way to cost analysis of whether a customer continues to bring profit to the enterprise or is beginning to represent a drain on profit. More about these types of dynamics will be described later in this specification.

In one embodiment, the receiving TBR is a cooperative TBR that functions as a proxy or moderator and has access to all or partial communications interaction histories of all other TBRs in a given trust network. This embodiment may be one in which interaction histories of each network actor are maintained in the network cloud by a trust network host analogous to TISP described with reference to FIG. 1 above. In this case, a host TBR may mitigate and establish trust relationships between any of the existing actors belonging to the network and may also be useful in sponsoring in new actors to a trust network by virtue of richer data available for use in mining for trust metrics that may be used to establish by implication, a level of trust for a new actor. In this way, an established trust network may grow dynamically. It is also noted that a trust network may retract dynamically as well if existing trust metrics are tied to time-based and/or performance-based data. One example using a cooperative TBR is described immediately below.

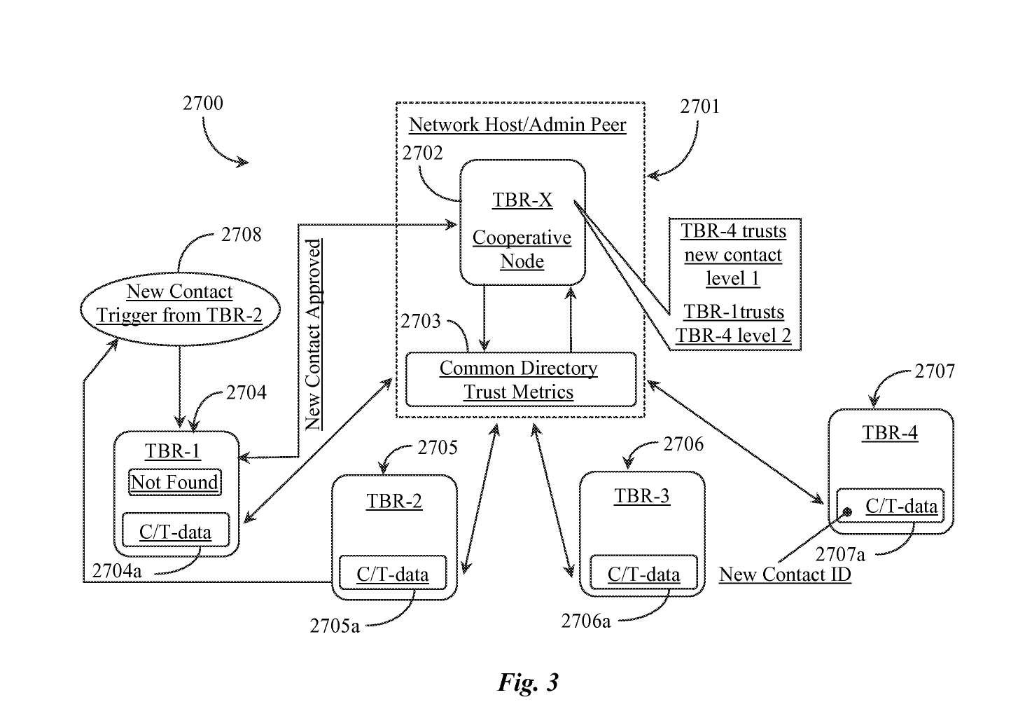

FIG. 3 is a block diagram illustrating interaction between a central trust-based router 2702 functioning as a trust proxy and other trust based routers in a trust-based network 2700 according to an embodiment of the present invention. TBR 2702, also labeled TBR-X is a cooperative TBR functioning as a trust proxy according to an embodiment of the present invention. In this example, TBR-X 2702 is hosted at the location of a network host or an administrative peer 2701. Host 2701 may be any centralized system maintaining network communication capabilities in a centralized fashion including maintenance of a common directory 2703 of trust metrics established by all of the other actors on the network and their latest interaction histories according to their covered communications programs or, in one embodiment, communications zones.

Directory 2703 includes at least all of the established actors trust metrics established between themselves and the latest interaction histories for each actor related to each other and other contacts they may communicate with regardless of whether they are members of network 2700 or not. The depth of interaction history for any one communication program for any one actor may vary according to that actor's whishes. For example, an e-mail history established by one actor may reach back 6 months while that of another actor may only reach back one month. The history may include at minimum, the identities of the contacts and any existing trust metrics or relationships definitions established for those identities. More than one communication program or channel and associated histories may be included, for example, in a communication zone. Therefore in a work zone, the supported communication channels may be VoIP, cellular telephone, and email. The interaction histories for that zone then would include all of the trusted contacts, and any contacts not implicitly marked for trust but found as an identity in at least one interaction associated with the zone.

This example presumes at least that there are 4 other network actors that have trust relationships established between individual ones of themselves as a group and between each actor and TBR-X 2702 as a trust proxy. The actors are represented in this example as TBR-1 (2704), TBR-2 (2705), TBR-3 (2706), and TBR-4 (2707). One with skill in the art will recognize that there may be more than 5 total actors in the network without departing from the spirit and scope of the present invention. The inventor illustrates 5 actors including TBR-X for explanatory purposes only and to show dynamics of interaction among them.

In network 2700, each actor has contact and trust data (T-data) configured locally, stored locally, and maintained locally on their device or devices used for communication. On TBR 2704, there exists C/T-data 2704a. C/T-data 2705a is accessible to TBR-2 2705 and so on for the rest of the TBRs illustrated. Each TBR 2704-2707 periodically has his or her latest C/T-data synchronized with, proxied to, or otherwise published to host 2701 where such data is appended to directory and database 2703. TBR-X 2702 therefore has access to all of the interactions histories, contact identities and trust metrics configured for all of the actors 2704-2707 including it as an actor. Each TBR 2704-2707 may have different levels and/or instances of trust configured amongst them. However, all of the TBRs 2704-2707 must trust TBR-X to the extent of allowing it to mitigate and, in some cases, to modify their inter-trust metrics established amongst themselves.

Database 2703 may be an optical storage, device memory, hard disk, or any other type of data storage facility without departing from the spirit and scope of the present invention. In a hosted network data mining for possible trust metrics for a particular communication is much richer than it might be for only 2 TBRs communicating. TBR-X 2702 has access to all of the interaction history of the network as well as all of the trusted contacts and trust metrics. Therefore, a new actor entering the network has a much better chance of being accepted if he or she has had some contact with any one of the member TBRs. To illustrate a typical interaction, consider the following example.

This example assumes that TBR-2 (2705) has initiated a first contact, illustrated herein as new contact trigger 2708 with TBR-1 2704. New contact 2708 triggers TBR-2 into operation. TBR-2 2705 has not had any prior interaction history with TBR-1 2704. Therefore, TBR-1 does not immediately recognize the identity of TBR-2. The trust network is mitigated by TBR-X 2702 by default so before applying default handling or filtering of the new event, TBR-1 pings TBR-X with a request to authenticate trust for the new event. In this embodiment, no TIML data needs to be sent along with the new communication event sent to TBR-1 from TBR-2.

TBR-X receives the request from TBR-1 and compiles TIML data for TBR-1 and TBR-2 from associated interaction histories and contact identities. TBR-X looks for common threads in the TIML data including established trust levels. TBR-X makes a determination that TBR-4 trusts the new contact to a level 1. That is to say that TBR-2 has already been established a direct level of trust with TBR-4 concerning at least the identity used in association with the new event. TBR-X also discovers that TBR-4 has established a level of trust established with TBR-1 to a level of 2 indicating that TBR-1 trusts TBR-4 and any contact that TBR-4 trusts directly. All of this data supporting the implication of a trust relationship is obtained by TBR-X from database 2703. No other TBR needs to be pinged or contacted. TBR-X has established that TBR-1 should trust the new event because it has extended trust to TBR-4 and a next level (all of the contacts that TBR-4 trusts directly). TBR-X then sends an instruction to TBR-1 to go ahead and trust the event. A system recommendation may also be sent inviting TBR-1 to extend his direct trust directory to include the identity of TBR-2 as presented in the communiqué. If TBR-1 agrees then TBR-2 may become part of the actor's (TBR-1) trust directory maintained in database 2703.

In one embodiment, TIML data is sent from TBR-2 to TBR-1 along with the communication event. It may be that there is enough data in the TIML of TBR-2 to establish the trust relationship. For example, if the new event is a VoIP call and TIML of TBR-2 includes VoIP interaction and trust metrics with TBR-4 then TBR-1 would immediately recognize TBR-2 by virtue of their common VoIP association with TBR-4. However, it may be that the interaction history between TBR-2 and TBR-4 is not VoIP but instead it is instant text messaging. Because the event is a VoIP event, the TIML sent with the event from TBR-2 may not have considered interaction history with instant text messaging. Likewise, TBR-1 may not have his instant messaging application configured for TBR. In this case, TBR-X would search for the commonalities using TIML compiled from any channels other than VoIP in an attempt to solve the problem. TBR-X then determines that the trust relationship between TBR-4 and TBR-2 includes a text-messaging channel. Therefore, the system may recommend to TBR-1 that it go ahead and trust TBR-2 for the VoIP call because the actor is in a trusted IM buddy list of TBR-4. TBR-1 may by default, accept system recommendations of this kind or it may alert the actor of the attempt to establish a trust relationship between the actors over the VoIP channel and let the actor (TBR-1) decide whether to take the call or not.

TBR-X is not restricted to any one communication channel for which it may consult interaction history and trust metrics related to found identities for any of the other actors. It may be physically restricted in a sense by creating constraints such as “imply trust relationships only for email and telephone communication”. If TBR-1 had this constraint in place as a trust metric then the fact that TBR-2 had an IM interaction history with TBR-4 may be irrelevant and no trust relationship might be implied for the new VoIP event. In this case the VoIP event would receive normal treatment, which might include non-acceptance. Even in this case, the system may send an alert to the sender of the event that informs the sender which communications channel the receiving party prefers for trusted communication over the network. There are many possibilities.

In one embodiment, new contact trigger 2708 may not be from any of the established network users and may be incoming from a user that does not have a configured TBR. In this case, a check by TBR-X may determine that the contact is a frequent CC identity in email interaction history of TBR-4 and TBR-3. This level of trust relationship established may not be enough to override default handling. However, a system message may be sent out to inquire if the host should invite the identity into the network and make a new TBR available. Each actor may then decide if that indeed should be the case whereupon they may forward approval to the administrator. The hosted example has more structure than a non-hosted network but each individual actor still has final determination over who to trust and who not to trust.

Trust relationships may be established with certain constraints as previously described. For example, one actor may be completely trusted by another actor for all supported channels except file transfers. For any event type, trust relationships may be extended further into content carried within the event vehicle including HTML, email attachments, audio, video, even images and graphics typically carried on Web pages. The same actor described above may, for example, only be trusted over the telephone by yet a third actor and so on. In this way, trust may be earned to some extent if the appropriate mechanisms are in place to enable it. For instance, Tom may trust Joe directly for all supported communications without reservation. As an extension of that trust relationship, Tom may also trust only the top 5 most active identities that Joe trusts. The motivation to gain direct trust from Tom may be that Tom is the top decision maker in the company. So in order to earn more trust from Tom, those identities interacting with Joe must demonstrate frequent collaboration before the system will imply that Tom may trust them. In this case, perhaps the interaction histories involve sales transactions and Joe is the intermediary sales manager under Tom. Perhaps the motivation then is to operate eventually directly under Tom instead of communicating through Joe thereby being promoted to Joe's level. There are many possibilities.

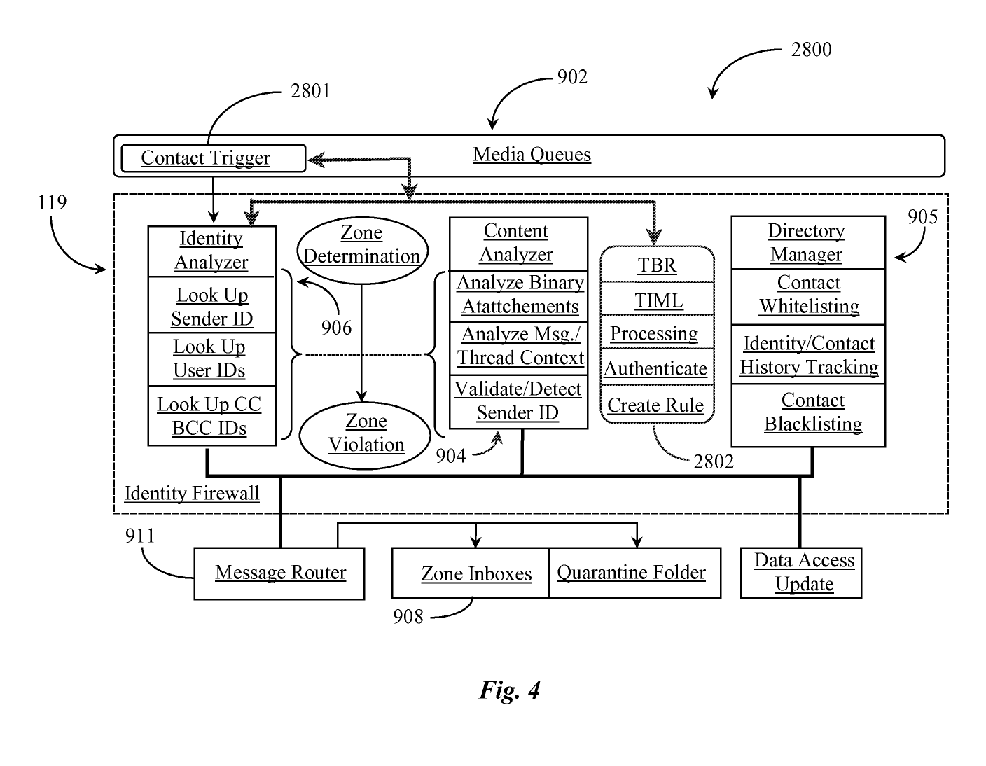

FIG. 4 is an architectural overview of an identity-oriented routing system 2800 enhanced with trust-based routing according to an embodiment of the present invention. Routing system 2800 is somewhat analogous to a system described with reference to FIG. 9 of Ser. No. 10/765,338. Many of the element numbers present in FIG. 9 of co-pending application 8600 are also present in this embodiment and therefore shall retain their previous descriptions and not given new element numbers.

In this example, trust-based routing is integrated with identity oriented routing wherein communication zones are set up for the receiving actor. Media queues 902 provide staging for incoming communications events, which may be of different communications types addressed to one or more identities of the actor, the identities typically generic to one or more zones in place to receive these events. Identity firewall application 119 handles final routing and replication by default if required of all incoming messages. Zone inboxes 908 represent all of the separate zones an actor may have set up to receive communication to and wherefrom the actor may initiate outgoing communications from. The identities used by the actor are key in this type of identity routing. Firewall 119 processes all incoming events and makes recommendations to message router 911, which may logically represent any type of event handler to route messages to appropriate zone inboxes 908 or to quarantine in the event no matching identity pairs are found. In default identity oriented routing (IOR), an identity analyzer 906 looks up the senders ID and the receivers ID to get a preliminary idea of how to route the event. The sender IDs are found in the actor's directory and are accessible through a directory manager 905. The IDs may be stored in one or more white lists, one or more black lists, and may be derived from identity contact history tracking. That is to say that identities may be pulled from interaction histories.

Identity analyzer may also check CCs and BCC IDs included with a message. Zone determination for end routing for events may be determined as well as zone violations for any outgoing messages. In further granularity, filtering may be ordered and based on content analysis. Content analyzer 904 provides this service and can analyze binary attachments, message thread contexts, and can detect, in some cases, a hidden or masked sender ID and validate that ID against a black list for example. All found IDs in this IOR system must be found either on one of the actor's white lists or on one of the actor's blacklists Otherwise the end routing destination for the event is in the quarantine folder or its equivalent handling routine, which may simply be not to answer an incoming event.

In one embodiment, the TBR (2802) of the present invention may be integrated within firewall 119 as an inserted routine, which attempts to establish a trust relationship to override the firewall before the firewall is allowed to dispose of the event. In this case, a contact trigger 2801 shows up in queue 902. Trigger 2801 represents an incoming event that may have TIML data associated with it. In one embodiment, firewall 119 may first attempt to preliminarily establish a routing destination based on identity analyzing. If this is successful then TBR 2802 may not be required to intervene and the TIML may be discarded. However, if the sender ID as represented is not found in either a white list or blacklist, then TBR 2802 may take over processing and receive the TIML data from the event. In processing, TBR 2802 retrieves TIML from the actor interaction histories of the communication type of the event and any other supported communication types that the actor agrees to include when attempting to establish a trust relationship with the sender. Identity analyzer 906 may also forward CC and BCC IDs to TBR 2802 as additional ID-based data that may match ID data within interaction history.

The TIML data received by TBR 2802 and that compiled by TBR 2802 for comparison also contains known trust metrics, which may be referenced in the actor's white lists of trusted contacts. In authenticating or in attempting, rather, to authenticate the sender, TBR 2802 compares TIML sets and trust metrics established by both sender and the actor and looks for commonalities. TBR 2802 may determine then that the particular sender ID, although not found in a white list of the actor, is actually a trusted contact of an identity that is listed in a white list of the actor. The trust metrics for that white listed identity extends trust from the actor to anybody that the identity trusts directly thereby establishing an implied trust relationship between the sender ID and the Actor ID. In this example, a rule may be created and appended to the firewall that may add to sender ID to a white list for the zone associated with the actor ID listed in the event. The next time that the sender communicates, the identity firewall may handle the event without running TBR 2802.

In one embodiment, TBR may be leveraged in-between identity analyzing and content analyzing. In this case, the actor may have specific content rules that mitigate approval of final routing of that content regardless of the findings of TBR 2802. Therefore, if TBR 2802 determines a non-white listed sender should be trusted, the firewall may still filter out certain content and may override or modify one or more trust metrics in place for the actors trust network.

For example, assume that Jimmy belongs to a church run by Pastor John. Pastor John is a white listed contact for the church zone of Jimmy. Jimmy has a church zone ID for his email communications with the church. Pastor John gave Jimmy's email address to a new church member that purported to need some counseling. The sender initiated an email with an attachment and sent it to Jimmy's email address. When the event arrives, identity analyzer 906 cannot validate the sender ID. TBR 2802 take over processing. The sender happens to have an interaction history (TIML data sent) in a trust network with another person from the church, Frank, who is a trusted contact of Jimmy's and who is on the white list for the church zone. TBR 2802 recommends preliminary acceptance of the message before the content is analyzed. The content analyzer takes over and determines that the attachment is jpeg along with a caption containing a profanity. The firewall then overrides the recommendation of TBR 2802 and quarantines the message. The sender ID may then be added to Jimmy's blacklist Frank's trust metrics may then be modified to exclude Jimmy's trust from anyone Frank trusts. The system may send a default message to Frank letting him know that the sender he trusts is performing inappropriately in church communication. Evidence then of a tasteless joke propagated by a new church member can be used to inquire about that member and to confront the member if need be about the behavior.

In one embodiment TBR 2802 may be bundled with existing routines adapted for end routing and filtering of messages. In another embodiment, TBR 2802 may be used as a standalone application without departing from the spirit and scope of the present invention. In still another embodiment, TBR 2802 may be adapted as a telephony routing routine in a cooperative mode that may be bundled in with telephony software running on a telephony routing system like a central office routing switch that may be computer telephony integrated (CTI) capable. In this embodiment, TIML data for an actor or user of the system may include prior telephony interaction history represented as telephone number pairs or telephone number sets of those participants in the interactions. Trust metrics for all trusted telephone numbers of the user, and in some embodiments, statistical result data for each interaction that indicates some positive or negative value that can be associated with the interaction in terms related to some business process. In this case TIML data may be made compatible with call center XML (CCXML) as an extension of that markup.

For example, a central office routing system for a retail business may route calls to several live agents and to one or more automated systems. Clients of the business may phone in to place orders, ask service questions, register as new customers, and the like. It is important to the business that time spent servicing customers is profitable. For example, a sales transaction my be the most profitable use of a sales agent's time while spending time answering questions about the business without logging a sales transaction is arguably a less profitable use of time. In this case, each new customer may be assigned a scaled down version of a TBR maintained by the host or central office. These versions may be manipulated to an extent by the clients, for example, to set trust metrics for agents or services persons of the company that the customer trusts. Likewise, agents and service persons may each have a TBR that may also be maintained by the host or installed at each agents or service persons communication device. In some embodiments, clients may use their own TBRs to set up their own trust metric filtering for their own trusted contacts such as business associates and friends. In the latter embodiment, the host may support or host trust network services in addition to selling its own products or services.

The central office router may have a coop TBR with conditional trust metrics set automatically for each customer to a high level or a fully-trusted, “valued customer”. As interaction ensues with respect to normal business, interaction statistics related to each interaction between the service and a customer may be logged and evaluated in TIML processing against some static value like a profit or loss threshold for each interaction between the customer and agent of the service. Trust metrics for each of the customers may then dynamically change over time due to analysis of these statistics, which may be part of TIML data compiled for the customer and agent the customer interacts with. In this example, the coop TBR may focus more on which customers turn out to be more valuable over time and may dynamically modify trust metrics for those customers originally granted at high level accordingly.

Therefore, if a customer demonstrates a rich interaction history with a live agent of the company and that history shows profitable interactions (sales order revenue), then the coop TBR may continue to trust that customer on behalf of that agent to the broadest level enabling the customer special access to his or her most trusted agent or service rep in timely fashion each time the customer calls in. However, if continued live interaction between a customer and agent proves un-profitable over time based on TIML analysis, then the TBR may dynamically reduce trust metrics for that customer such that eventually he or she no longer reaches the live agent but is routed to an automated system instead. Such a TBR network may be tuned to increase profits for a company by focusing more attention on customers who support the business by placing orders and less attention to those that continue to drain resources without placing orders.

In a variation to the commercial example described above, a professional, perhaps an investment advisor, may set up a personal trust network between him or her self and his or her clients wherein a trust may be earned by the professional who is in competition with the other like professionals who could compete for the customers business. In this embodiment, new customers are given a TBR and a set of pledges made by the professional. The customers may use their TBRs to set up their own personal trust networks with their peers, family, friends, and associates. The professional may initially make a promise in return for eventual trust at the point of sale. For example, if the professional is an investment advisor handling client investment portfolios, he may pledge that he or she will increase the clients net worth of the client portfolio by an average of 8% over 90 days and that whenever the client makes contact, a response will be provided within 24 hours. If the pledge bears truth over time, the customer agrees to send the professionals contact information and a recommendation to all of the client's trusted members of his or her personal trust network.

In this embodiment, the professional has an incentive to work harder for his clients and when his client makes a recommendation to one or more of his or her trusted contacts, his or her own level of trust can be enhanced in view of the other network members by virtue of the fact that the individual has provided a valuable contact to his or her trust network members. In this way, a trust network may be set up as a networking tool and as one where competition may exist for specific trust levels. For example, if one of the client trust networks is large, it may be conceivable that a competing investment advisor has fulfilled a set of pledges for one of the clients trusted associates that are more valuable than those pledges by the original professional. The persuasive component in this type of networking is that the proof of quality of the referral is documented for the client and therefore may be trusted by those in the client's sphere of trust. There are many possible variations for trust based networking both in business and in social environments.

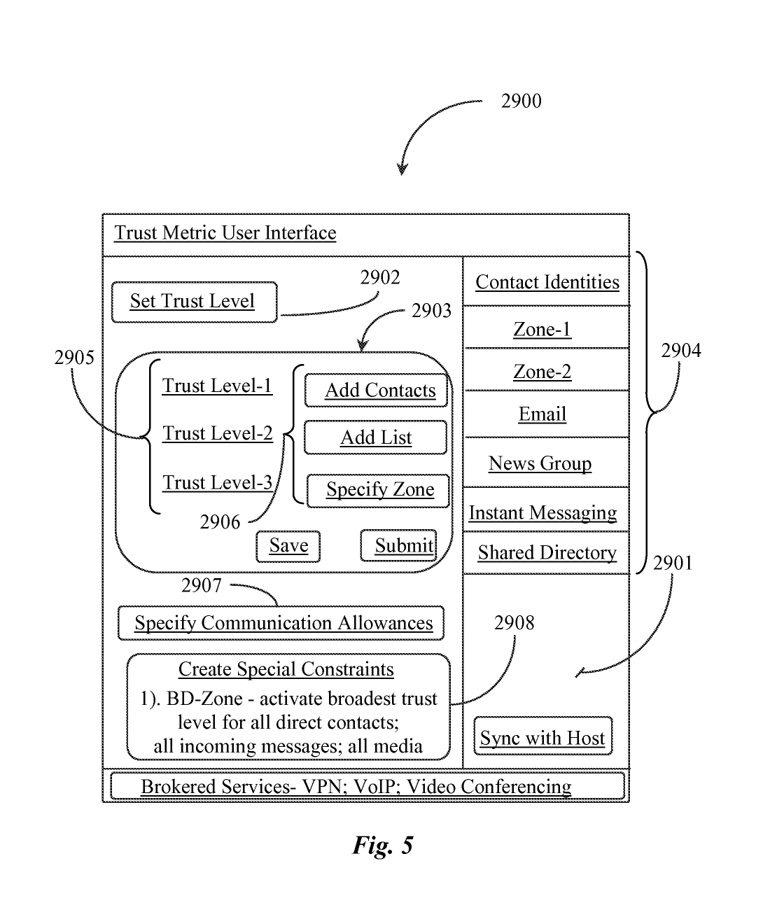

FIG. 5 is a plan view of a configuration user interface 2900 for establishing and modifying trust metrics according to an embodiment of the present invention. User interface 2900 may be a resident interface integrated with a resident TBR, or it may be a network served interface for setting metrics for a TBR held in the network cloud, for example, by a host without departing from the spirit and scope of the present invention.

It is noted herein that a TBR at full interactive capability is adapted to enable any user thereof to establish one or more trust networks that include any contacts known to the user that the user may deem trustworthy to any level of trust. Therefore, more than one trust network may be established by the user regardless of whether the contacts added to the established networks have TBRs themselves or not. A column area 2901 is available within interface 2900 that is adapted to list specific structures that may include contacts specific to the structure listed. For example, options 2904 illustrate a Zone-1, a Zone-2, an email account, a news group, an IM account, and a shared directory of contacts. Clicking any of the accounts and then invoking contact identities may produce a list of contacts that are specific to the selected account or structure. Selection zone-1 for example, and invoking the contact identity indicia will bring up a list of all contact identities that are approved for incoming and outgoing message routing with regard to zone-1, which may be a work zone for example. It is noted that zone-1 is a structure and that more than one communication program may be approved for communication between the owner and the contacts of zone-1. Therefore, a contact identity for zone-1 may include an email address, a telephone number, and so on.

The same is true for the structure zone-2, which may be a social zone for example. Here, the contact identities may include email, telephone or other contact addresses of contacts approved for communication through zone-2. Zone-1 and zone-2 may share some contacts. Email contacts are simply those contacts associated with the owners email account. News group contacts are those that the owner interacts with through one or more news group. IM contains the contacts listed for the owners IM account. Shared directory contains contacts that are shared between the owner and one or more contacts of the owner. For example, several contacts found for zone-1 may be shared by all or designated ones of the contacts other than the owner, who are approved for communication through zone-1. Each of the listed structures with the exception of the shared directory may have an inbox and/or some event queue structure adapted for staging incoming events and a quarantine folder, a Spam folder or a routing routine for isolating certain messages that are destined to the structure, but wherein the sender identity is not on the list of approved contacts for that structure as described in IOR embodiments with reference to the co-pending applications.

Interface 2900 has a main window containing indicia 2902 labeled set trust level. Invocation of set trust level 2902 may bring up a window 2903 containing selectable trust level options 2905 listed herein as trust level-1; trust level-2; and trust level-3. Options 2906 include indicia for adding contacts, for adding a contact list, and for specifying a zone. Trust levels 1-3 may be such that level-1 is the minimum trust, level-2 is the moderate trust, and level-3 is the maximum trust. There is no particular hierarchy or order required in order to practice the present invention. Trust level-1 may be defined as the user will directly trust the contact but that is all. Level-2 may be defined as the user will directly trust a contact and extend implied trust to anyone that contact trusts directly. Level-3 may be defined as the user trusts any of the contacts that are trusted by the contact to which trust is extended.

A user may add contacts manually for each trust level by clicking on the appropriate trust level desired and the clicking add contacts to network. Lists may be compiled and added, or they may already exist. Indicia 2907 enables the user to specify communication allowance for the trusted contacts. For example, a trusted contact from the email list may be restricted to use of email in correspondence with the user by default. However, a user may add contact data for any contact and approve communication for any contact using any available program.

A window 2908 is provided and adapted to enable the user to create special constraints governing trust based routing. For example, if zone-1 is a business development zone, the user has created a rule activating a level 3 trust metric for all of the contacts directly listed as zone-1 contacts and for all incoming messages using any supported media. In a hosted embodiment, user interface 2900 may include a synchronization option 2910 adapted to enable the user to synchronize interaction histories and contact data including trust metrics with a host analogous to TISP 2504 describe with reference to FIG. 1. A user may configure his or her communications applications and contacts for trust based routing whether the TBR application is resident on the configuring device or maintained in the network by a host service.

In one embodiment of the present invention, a trust network administrator such as a cooperative TBR may broker services to members of the network as may be needed for communication or collaboration. VPN, VoIP, and video conferencing service may be brokered to certain members of a trust network deemed to require those services. In some embodiments, QoS and other network services like tunneling may be provided. It is noted herein that a trust network may be as small and as informal a 2 or 3 users operating TBR applications that trust each other to some level. A trust network may also be a vary large network of 100 or more users that communicate through a trust proxy or host TBR.

Any user operating a TBR may set up one or more trust networks regardless of whether contacts selected for trust configuration also have a TBR. For example, if a user Joe has a TBR, he may configure a user John as a trusted contact for email. He may extend the level of trust to John such that Joe may also trust any of his trusted contacts without John's input. This embodiment requires that John download and install a TBR and that John configure his own trusted contacts to a direct level of trust. Even in this embodiment, should one of John's trusted contact send an event to Joe, Joe's TBR would not recognize that identity as one of John's trusted contacts if the user does not have a TBR capable of sending TIML data. Therefore, when John first configures his trusted contacts, his TBR may compile a TIML set noting the identities and trust metrics assigned to them. John may then contact Joe to conduct a TIML exchange. Joe's TBR may archive John's TIML data that includes the identities of all of John's trusted contacts. Hence, when a trusted contact of John contacts Joe without a TBR, Joe's TBR may check TIML archive data and determine that the sender is in fact one of John's trusted contacts. Therefore, that user may be treated as a trusted contact instead of being routed to a Spam folder or junk box.

Of course it is desirable that second level trusted identities eventually obtain a TBR and configure their own contacts, communications programs and trust metrics. However, it is not strictly required unless those users which to control the levels of trust allowed for their incoming events. Once a second level user has interacted with Joe it is now part of Joe's interaction history and Joe may extend a first level of trust to the user even if the user has no TBR application. Other random events coming in may be checked by default against TIML sets acquired from Joe's trusted contacts that do have TBRs to determine if any trust relationship may be inferred for the sender identities of those incoming events. In this way, John may extend access to an inbox owned by Joe to associates that he deems should have access to Joe's inbox as long as Joe agrees by extending the trust level of John to include those associates that John trusts. A user does not have to have a running instance of TBR in order to be listed as a trusted contact in another users TIML data. A user only has to have a TBR running if that user desires to limit access to his or her own trusted inboxes and so on to contacts based on level of trust.

In one embodiment, UI 2900 includes a trust advisor module (not illustrated), that may be used in interaction between a user and the system (hosted or published trust network) to provide system recommendations and assistance to the user in various task performance scenarios like configuring trust, determining whether to trust a system recommended contact, and so on. A trust advisor module may also be invoked as a system aid in helping new users configure outbound events or to enable trust network look-up of any possible contacts that the user may include in his or her trust network or may target for sending a trust interaction of event to.

In one embodiment, a user may search for available contact directories using the trust advisor, and then select those directories he or she wishes to make available to all of the other trusted network users. Virtually any type of published directory may be shared among trust network users. In one aspect in a variation of implied trust advisement or system recommendation to a user of a plausible trust relationship, the trust relationship discovered relates to one or more contacts included in a network-based directory the discovery communicated to the sender as an advisory before routing an outbound event received from the sender to the one or more contacts. There are many possibilities.

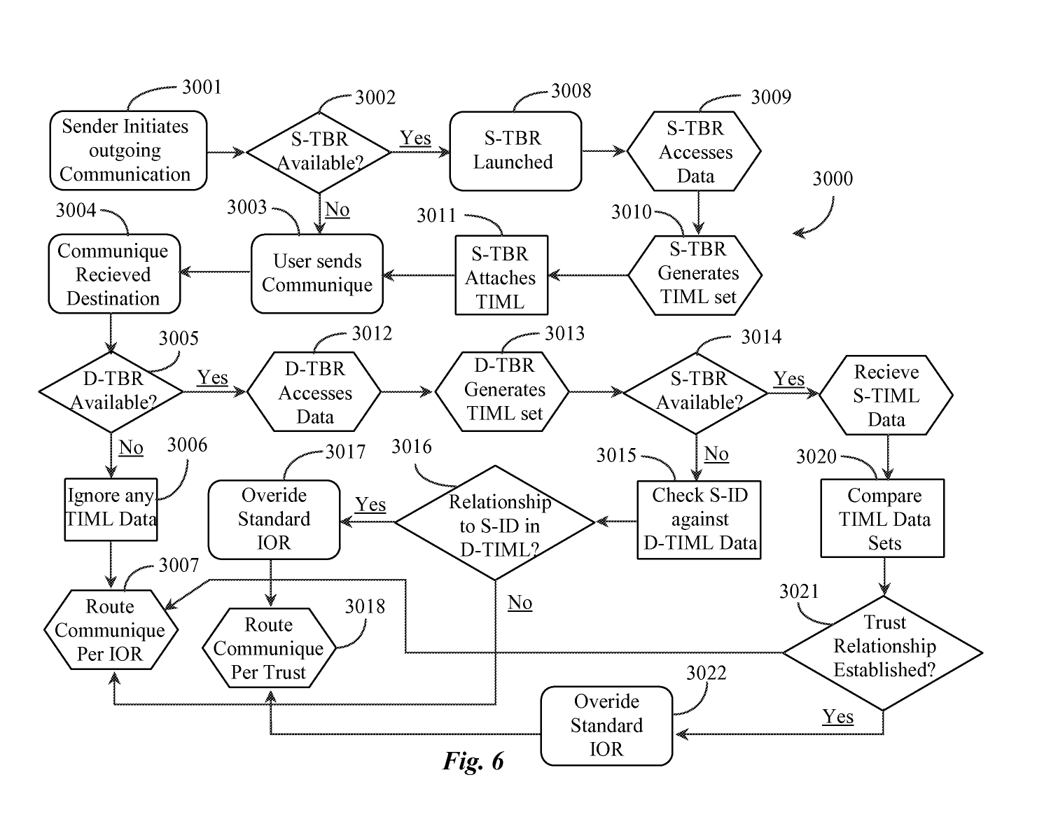

FIG. 6 is a process flow chart 3000 illustrating steps for verifying trust metrics in an ad hoc communication sequence according to an embodiment of the present invention. At step 3001, a sender initiates an outgoing communication event. The event may be any form of communication asynchronous or synchronous. At step 3002, the process may vary depending on determination of the existence of a sender-based TBR (S-TBR). If no S-TBR is available, then at step 3003 the sender sends the communication event over normal channels. At step 3004, the destination point receives the communication event or notification thereof in some instances depending, of course on the nature of the communication. If there is no destination TBR available at the receiving point of the event or notification thereof as determined at step 3005, then step 3006 is not necessary and may be skipped. The event is treated as a standard event routed according to existing regimens such as identity oriented routing (IOR) at step 3007. At step 3007, the event may be routed by any other existing protocol set up for the purpose. This is normal communication without benefit of trust-based routing.

At step 3002, if an S-TBR is available, then it is launched at step 3008. At step 3009, the S-TBR accesses data like the sender ID and destination ID of the event, the communications type of the event, any relevant interaction history and any existing trust metrics associated with either of the identities to a degree configurable by the user. For example, data accessed may be limited to interaction history pertinent to the communication event type, perhaps email, and the information (trust metrics) assigned to all of the senders trusted contacts listed in the address book of that email program. At step 3010, S-TBR generates a TIML data set containing the data as XML-based markup.

At step 3011, S-TBR attaches the TIML data set to the event being initiated and sent. The process resolves back to step 3003 wherein the event is sent, this time with a TIML data set attached. At step 3004 then, the communiqué or notification thereof is received. At step 3005, if there is no destination TBR (D-TBR) available, then the TIML data sent cannot be recognized and is discarded or ignored at step 3006. The communiqué is still routed at step 3007 using existing protocol like IOR.

Now assuming that an S-TBR is not available at step 3002 and the communiqué is sent at step 3003 and received at destination at step 3004, there is an opportunity for trust-based routing if a D-TBR is available at step 3005. In this case, the D-TBR may be configured to intercede for all incoming messages. In this case, the D-TBR accesses data from interaction history and trust metrics established for the destination including any archived TIML sets acquired during a TIML exchange with another trusted TBR at step 3012. At step 3013, D-TBR generates a TIML data set. Verifying that there was no S-TBR at step 3002, by confirming at step 3014, confirmation verifiable by the absence of a TIML data set attached to the communiqué or notification thereof, at step 3015, the D-TBR checks the sender ID of the communiquéagainst D-TIML data. The process attempts to place the sender ID with any of the destinations trusted contacts, interaction histories, or trust metrics associated with those contacts. At step 3016, it is determined whether a trust relationship to the sender ID was found in the D-TIML. If yes, then a trust-based routing instruction overrides standard IOR or other routing treatment of the communiqué at step 3017. At step 3018, the communiqué is routed according to trust extended to the sender.

It may be that the trust relationship established was by virtue of the sender's relationship with one or more of the destinations trusted contacts. This fact might have been determined through the archived TIML previously acquired from a trusted contact. It may also be that the sender ID was a trusted contact configured in D-TBR trust setting even though the sender did not have an S-TBR. Still further, it might have been an interaction history between a trusted contact of the destination and the destination wherein the sender ID is listed as a frequent CC in events received from the trusted contact. The trust relationship in that case might have been system suggested or recommended. The communiqué was afforded trust-based routing in this example, even though the sender did not have a TBR running and had not previously contacted the destination. Also, no direct involvement was required by any other router to establish that the sender could be trusted by the destination.

In the event that no trust relationship could be established for the sender at step 3016 after TIML processing of step 3015, then the communiqué is routed according to IOR or other existing protocols. In another aspect, there is an S-TBR at step 3002 and also a D-TBR at step 3005. In this case, the S-TBR is launched at step 3008, accesses data at 3009, and generates a TIML set at step 3010, and attaches the TIML to the communiqué or notification thereof at step 3011. After receiving the communication at step 3004 and it is determined that a D-TBR is available at step 3005, then D-TBR accesses data at step 3012, generates its own TIML data at step 3013, and confirming an S-TBR availability at step 3014, the D-TBR receives or strips the S-TIML data from the communiqué. It is noted herein that in one embodiment, the S-TBR may initiate and establish a data link to the D-TBR if it is known to be available prior to sending the communiqué. In this case, TIML may be passed to D-TBR over the link established, which may be separate from the communication channel used.

At step 3020, the D-TBR compares TIML data sets or S-TIML against D-TIML and looks for a trust relationship for the sender ID. The evidence of a trust relationship for the sender may be contained entirely in the S-TIML, but verified indirectly from D-TIML. For example, the sender may be a trusted contact of a trusted contact of the destination ID. Therefore, the sender is identified through the S-TIML, but authenticated by a piece of D-TIML indicating that the destination trusts all contacts of the primary contact. The fact that both parties employed a TBR aids in streamlining processing of TIML data. At step 3021, if a trust relationship is established that passes the metrics set by the destination, the standard treatment is overridden at step 3022 and the communiqué is routed according to trust at step 3018.

In one embodiment, a trust indication may be present but a valid trust relationship may not be fully established. An example might be an indication that the sender is in fact a trusted contact of a trusted contact of the destination, and that the destination trusts all trusted contacts of the common contact except for telephone, wherein the communiqué is a telephone call. In this situation, or one similar to it, the destination user may receive a pop-up notification or other indication asking for a manual determination to accept or reject the call. Interacting with the notification such as by clicking yes or no may make the determination for the user. The process variations described in this example are possible in an ad hoc trust network environment that does not use a host or maintain a centralized database of interaction histories available to a proxy router. It is noted that a sender TBR is not required for the sender to be trusted in the network. However, a TBR is required at the destination for an incoming communication event to be routed according to any trust metrics.

One with skill in the art will recognize that the basic process of the present invention may exhibit several variations without departing from the spirit and scope of the present invention including those of which trust routing is possible even though the senders may not have a running instance of TBR available at the sending device. In one embodiment TIML data sets of contacts trusted by a user may be archived by the user for later use in identifying communiqués received from trusted associates of those contacts, the associates having no prior communication history per se with the user.

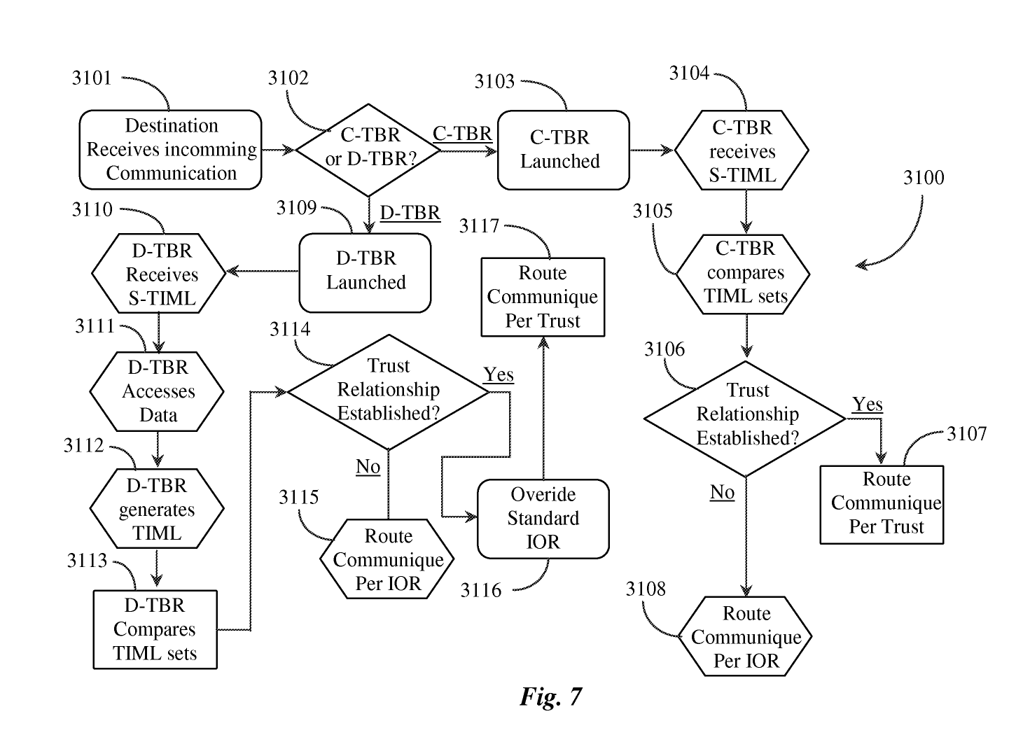

FIG. 7 is a process flow chart 3100 illustrating steps for verifying trust metrics in a proxy communication sequence according to an embodiment of the present invention. In this process it is assumed that the sender of the communiqué or communication event has a TBR installed and therefore has either attached a TIML data set to the event or has directly sent TIML associated with the event via a separate direct link to a destination TBR.

At step 3101, the destination point receives an incoming communication event or notification thereof into a routing system adapted to end route the event to the appropriate inbox, queue, or other staging mechanism. At step 3102, there are 2 paths dependent on whether the end point is running a standard destination TBR or a cooperative TBR functioning as a proxy. In the event of a D-TBR, the D-TBR is launched at step 3109. This represents a normal sequence between 2 TBRs with no proxy function. At step 3110, the D-TBR receives the S-TIML data set attached to the event or sent directly to the TBR whereby the associated event is identified.

At step 3111, the D-TBR accesses data locally associated with the receiver of the event the data may include interaction history, identities, and trust metrics. At step 3112, the D-TBR generates a TIML data set of that information for use in comparison. At step 3113, the D-TBR compares the TIML data sets to look for any hard evidence of a trust relationship that may be established between the sender identity of the event and the receiver identity of the event. It is important to note herein that the sender may have other identities that are known to the receiver but that are not necessarily the identity associated with the incoming event. The receiver's interaction history, perhaps of a different communications program or even device may reference one or more identity that might be positively associated to the sender identity used in the communication event. For example, if the sender is Joebing@123net.net, the event is an incoming email message. D-TIML generated from interaction history may not reference the exact identity but may find that, for example, Joseph Bing is a trusted telephone contact. The system may then recommend that the receiver trust the email message because of the relationship.

At step 3114, if no relationship to the sender can be established, then at step 3115 the email, in this case, is routed according to IOR or other existing filtering and the email may be routed to a Spam folder for example. If at step 3114, a trust relationship is established then the IOR or other standard filtering mechanism may be overridden at step 3116 and the email may be routed to a trusted inbox per trust level at step 3117. It is important to note herein that the system may find evidence of a trust relationship that may be suggested or implied, but not necessarily accepted by the receiver's trust metrics. For example, the receiver may approve of communicating with Joe Bing using a telephone, but not through email. In this case the receiver may be notified with a pop-up message like “The sender is a trusted telephone contact, do you wish to extend your level of trust to the sender for communication through your default email program”? At this point the receiver may click on a Yes or a No option, or if an audio alert, may say “Yes” or “No”. The exact method of alert will depend on the method of communication and the device receiving the communication.

Referring now back to step 3102, if at step 3102 the end routing point is running a C-TBR, then the C-TBR is launched if not already active at step 3103. At step 3104, the C-TBR receives the S-TIML either directly from the S-TBR, or via stripping from the incoming event. It is noted herein that a C-TBR may have access to data from all other TBR-enhanced actors belonging to the network and may generate specific TIML data sets for any of them for comparison. It is noted herein that one TIML set does not have to be ordered based on any information received in order to practice the present invention. However, as an enhancement to speed processing, in a cooperative proxy embodiment, the actors (networked TBRs may have already generated TIML sets for comparison and regular update by publish or synchronization relieving C-TBR of the task of accessing data and then generating TIML sets. One consideration in this regard is that in the event the sender has no TIML then it is possible that all of the TIML accessible to the proxy router will be accessed and searched for commonalities that may be linked to the sender identity. The C-TBR may be running at a network location like on a server, or in a routing system adapted to route incoming messages. The incoming message may be one that arrives at a destination, which may be that of an actor belonging to the trust network and which may be remote from the location of a cooperative mode. Likewise the cooperative node, in one embodiment, may be any other actor location instead of at a central facility.

At step 3105, C-TBR compares TIML data sets including S-TIML data and TIML data associated with at least one, more that one, or all of the other network actors. This is possible because all of the other network actors periodically synchronize or publish their interaction histories, contact identity data, and trust metrics with the host in a hosted embodiment, whether the host is centralized or just a station of one of the actors. The exact scope of synchronization of this data to the host from any particular actor is ordered and controlled by that actor. Having this data in one central location allows the C-TBR to pre-generate TIML data sets for all of the actors to the scope that the actors allow. Therefore, the success factor that the communication event received will be established as a trusted event is greatly enhanced because more than one TIML data set may be consulted during processing of the message.

At step 3106, it is determined whether a trust relationship may be established between the sender and the destination. If yes, then the event may be routed according to trust at step 3107, bypassing normal filtering at the destination. If not then the event is routed at the destination according to normal metrics in place at step 3108. It is noted herein again that the destination may be the station or device of any of the actors belonging to the trust network, the event sent by any of the other actors or by a user not yet inducted into the trust network. Likewise, the destination may be a centralized system such as a central facility or routing switch, soft router, or the like in place to physically handle communication for the network actors. In this process, it is assumed that the sender is a network actor running a TBR however, that is not specifically required in order to practice the present invention. The sender may be any user having contact information for communication with any of the actors. Likewise, trust based routing may be afforded to the sender even though the sender may not posses a TBR capable of generating and associating TIML data with the communication event. The process and variations thereof described in this example should in no way be construed as limitation to the method of the present invention.

There are many network situations where a trust network may come into play. For example, in one embodiment, a trust network may be set up for a family that shares a common communication interface like AOL™ or MSN™. In this embodiment, one or more administrators may have TBRs installed and may also be an administrator or moderator for a TBR of one or more minor children allowed to use the interface. In this case, the TBR of a minor may be configured to trust only those communications from sources that the parents trust, but may be flexible to an extent as to enable implied trust for new sources beneficial to the minor. In a simple example, the parent may set up a TBR for a child by adding initial approved contacts and setting up trust metrics for those contacts including any second level trust extensions with some conditions. A parent TBR would moderate interaction activity of the child. In this case, if a new sender contacts the child and there is some trust relationship that might be implied but not necessarily in full agreement with existing trust metrics, the parent may be automatically notified of the possibility and may then decide manually whether to extend trust to the new source. There are many possibilities.

The methods and apparatus of the present invention may be practiced over the Internet network, an Intranet network, a LAN network, and over other communications networks that might be bridged for communication with any data network such as the PSTN network and other wireless analog and digital carrier networks. The present invention may also be practiced using some or all of the described components including specific combinations thereof without departing from the spirit and scope of the present invention. Likewise, the present invention may be practiced using network-capable communications devices including, but not limited to computer stations, telephones, personal digital assistants, cellular telephones, VoIP systems, teleconferencing systems, paging devices, and small handheld computing devices. Therefore, in light of the many possible embodiments, many of which are described herein, the invention should be afforded the broadest possible consideration under examination for what is claimed with respect to the following claims introduced below.

What is claimed is:

1. A system comprising:
(1) a first computerized appliance dedicated to a first user and comprising:
a first processor;
a coupled first data repository storing first contact identities and trust metrics associated with the individual ones of the first contact identities;
one or more communication applications executable by the first processor; and
trust software executing on the first processor from a non-transitory medium;
(2) a second computerized appliance dedicated to a second user and comprising:
a second processor;
a coupled second data repository storing contact identities and trust metrics associated with the individual ones of the contact identities;
one or more communication applications executable by the processor; and
trust software executing on the second processor from a non-transitory medium; and
(3) a network coupling the first and second computerized appliances;
wherein, in a process of sending or receiving a communication over the network using one of the communication applications, the first computerized appliance, noting contact identities associated with the communication, interacts with the second computerized appliance, determining one or more routing decisions by consulting the trust metrics associated with the first and second contact identities.

2. The system of claim 1 further comprising three or more computerized appliances coupled to the network, the three or more computerized appliances forming an interactive trust network of members by virtue of the trust software executing in individual ones of the computerized appliances enabling interactivity in sharing trust metrics associated with contact identities among individual ones of the computerized appliances.

3. The system of claim 2 further comprising a central server in the network, the central server coupled to a data repository, wherein the central server stores a profile having contact identities associated with trust metrics for each of the appliances in the network, and wherein sharing of trust metrics and determining routing decisions is accomplished by the central server for individual ones of the members.

4. The system of claim 2 wherein the communications sent or received are text-based communications, including at least email, chat, news posting and instant messaging.

5. The system of claim 2 wherein the communications sent or received are voice or image-and-voice (video) communications, and the computerized appliances include smart telephones.

6. The system of claim 2 wherein interaction between member appliances concerns contact identities and associated trust metrics for persons who are not members of the trust network.

7. The system of claim 2 wherein the communication includes sharing digital content, and the interaction determines trustworthiness of sources of digital content.

8. The system of claim 7 wherein the digital content includes one or more of video files, text files and audio files.

9. A method comprising the steps:
(a) considering, by a first computerized appliance having stored contact identities associated with trust metrics and executing trust software from a non-transitory medium, a communication received or prepared to be sent, the communication having associated contact identities;
(b) interacting by the first computerized appliance with a second computerized appliance, consulting trust metrics associated with each computerized appliance, based on the contact identities associated with the communication; and
(c) determining one or more routing decisions for the communication based on any trust metrics found associated with the contact identities associated with the communication.

10. The method of claim 9 further comprising three or more computerized appliances coupled to the network, the three or more computerized appliances forming an interactive trust network of members by virtue of the trust software executing in individual ones of the computerized appliances enabling interactivity in sharing trust metrics associated with contact identities among individual ones of the computerized appliances.

11. The method of claim 10 further comprising a central server in the network, the central server coupled to a data repository, wherein the central server stores a profile having contact identities associated with trust metrics for each of the appliances in the network, and wherein sharing of trust metrics and determining routing decisions is accomplished by the central server for individual ones of the members.

12. The method of claim 10 wherein the communications sent or received are text-based communications, including at least email, chat, news posting and instant messaging.

13. The method of claim 10 wherein the communications sent or received are voice or image-and-voice (video) communications, and the computerized appliances include smart telephones.

14. The method of claim 10 wherein interaction between member appliances concerns contact identities and associated trust metrics for persons who are not members of the trust network.

15. The method of claim 10 wherein the communication includes sharing digital content, and the interaction determines trustworthiness of sources of digital content.

16. The method of claim 15 wherein the digital content includes one or more of video files, text files and audio files.
